(19) United States
(12) Patent Application Publication
(10) Pub. No.: US 2026/0149894 A1
(43) Pub. Date: May 28, 2026

(54) IMAGING APPARATUS AND OPERATING METHOD OF IMAGING APPARATUS

(71) Applicant: SAMSUNG ELECTRONICS CO., LTD., Suwon-si (KR)

(72) Inventors: JAEKYU LEE, Suwon-si (KR); WOOSEOK CHOI, Suwon-si (KR)

(73) Assignee: SAMSUNG ELECTRONICS CO., LTD., Suwon-si (KR)

(21) Appl. No.: 19/294,995

(22) Filed: Aug. 8, 2025

(30) Foreign Application Priority Data
Oct. 25, 2024 (KR) 10-2024-0147951

(51) Int. Cl. H04N 25/531; H04N 25/532; H04N 25/78

(52) U.S. Cl. CPC H04N 25/531; H04N 25/532; H04N 25/78

(57) ABSTRACT

Provided is an imaging apparatus including an image sensor including a pixel array that includes a plurality of pixels in a matrix form, the image sensor being configured to output first image data captured in a rolling shutter mode and second image data captured in a global shutter mode, and at least one processor configured to process the first image data and the second image data and output third image data based on the processing.

### CROSS-REFERENCE TO RELATED APPLICATION

This application claims priority under to Korean Patent Application No. 10-2024-0147951, filed on Oct. 25, 2024, in the Korean Intellectual Property Office, the disclosure of which is herein incorporated by reference in its entirety.

### BACKGROUND

Embodiments of the present disclosure relate to an imaging apparatus and an operating method of the imaging apparatus. In detail, the embodiments of the present disclosure relate to an imaging apparatus and an operating method of the imaging apparatus that generates an image with improved quality using image data captured in each of a global shutter mode and a rolling shutter mode.

An image sensor is a device that converts optical signals into electrical signals. A processor of an imaging apparatus may perform image signal processing of image data output from the image sensor to improve the quality of the image data.

Imaging apparatuses are being advanced to improve image quality in various environments. For example, in addition to conventional imaging apparatuses provided with an image sensor operating in a rolling shutter mode, there are imaging apparatuses provided with an image sensor operating in global shutter mode. A rolling shutter effect may exist in image data output by the image sensor operating in the rolling shutter mode.

### SUMMARY

One or more embodiments provide an imaging apparatus and an operating method of the imaging apparatus, which has an image sensor capable of capturing in each of a global shutter mode and a rolling shutter mode and which can generate an image with improved quality by using image data captured in each of the global shutter mode and the rolling shutter mode.

According to an aspect of one or more embodiments, there is provided an imaging apparatus including an image sensor including a pixel array that includes a plurality of pixels in a matrix form, the image sensor being configured to output first image data captured in a rolling shutter mode and second image data captured in a global shutter mode, and at least one processor configured to process the first image data and the second image data and output third image data based on the processing.

According to another aspect of one or more embodiments, there is provided an imaging apparatus including an image sensor including a pixel array that includes a plurality of pixels in a matrix form, the image sensor being configured to generate first image data in a rolling shutter mode and second image data in a global shutter mode based on a shooting command received from at least one processor, and output the first image data and the second image data, a memory device configured to store the first image data, the second image data, and stores at least one command executed by the at least one processor, the memory device being electrically connected to the at least one processor, and the at least one processor configured to execute the shooting command to transmit the shooting command to the image sensor based on a user input that instructs to capture an image or a video and generate third image data by changing a pixel location of pixel data of the first image data based on the second image data or by changing a pixel value of pixel data of the second image data based on the first image data.

According to still another aspect of one or more embodiments, there is provided an operating method of an imaging apparatus including receiving a user input that instructs to capture an image or a video, transmitting, by at least one processor, a first command that instructs to capture the image or the video to an image sensor based on the user input, generating, by the image sensor, first image data in a rolling shutter mode based on the first command, outputting, by the image sensor, the first image data, generating, by the image sensor, second image data in a global shutter mode based on the first command, outputting, by the image sensor, the second image data, and generating, by the at least one processor, third image data based on the first image data and the second image data.

### BRIEF DESCRIPTION OF DRAWINGS

Embodiments will be more clearly understood from the following detailed description taken in conjunction with the accompanying drawings in which:

FIG. 1 is a diagram showing an imaging apparatus according to one or more embodiments;

FIG. 2 is a diagram showing an image sensor according to one or more embodiments;

FIGS. 3A and 3B are timing diagrams describing operations in a global shutter mode and a rolling shutter mode of an image sensor according to one or more embodiments;

FIG. 4 is a block diagram of a pixel group according to one or more embodiments;

FIG. 5 is a circuit diagram of a pixel group according to one or more embodiments;

FIGS. 6A and 6B are diagrams describing sub-pixels according to one or more embodiments;

FIGS. 7A, 7B, 7C, 7D, 7E, and 7F are diagrams describing operations according to shooting modes of an imaging apparatus according to one or more embodiments;

FIGS. 8A, 8B, and 8C are diagrams describing image data used for synthesis when an imaging apparatus according to one or more embodiments performs the synthesis of the image data;

FIGS. 9A, 9B, 9C, 9D, and 9E are diagrams describing operations in which the imaging apparatus according to FIG. 8A synthesizes global shutter image data and rolling shutter image data;

FIG. 10 is a diagram describing an operation in which the imaging apparatus according to FIG. 8B synthesizes the global shutter image data and the rolling shutter image data;

FIGS. 11A and 11B are diagrams describing operations in which the imaging apparatus according to the embodiment of FIG. 8C synthesizes the global shutter image data and the rolling shutter image data;

FIG. 12 is a block diagram describing an image sensor according to one or more embodiments;

FIG. 13 is a block diagram describing an image sensor according to one or more embodiments;

FIG. 14 is a block diagram describing an imaging apparatus according to one or more embodiments; and

FIG. 15 is a flowchart describing an operating method of the imaging apparatus according to one or more embodiments.

### DETAILED DESCRIPTION

Hereinafter, one or more embodiments will be described.

It will be understood that, although the terms first, second, third, fourth, etc. may be used herein to describe various elements, components, regions, layers and/or sections (collectively “elements”), these elements should not be limited by these terms. These terms are only used to distinguish one element from another element. Thus, a first element described in this description section may be termed a second element or vice versa in the claim section without departing from the teachings of the disclosure.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

As used herein, an expression “at least one of” preceding a list of elements modifies the entire list of the elements and does not modify the individual elements of the list. For example, an expression, “at least one of a, b, and c” should be understood as including only a, only b, only c, both a and b, both a and c, both b and c, or all of a, b, and c.

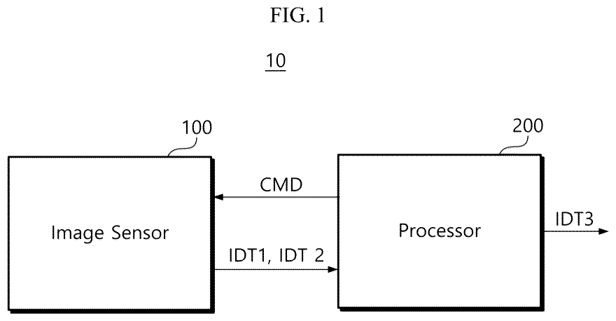

FIG. 1 is a block diagram exemplarily showing an image sensor 10 according to one or more embodiments.

The imaging apparatus 10 according to one or more embodiments may process image data captured in each of a global shutter mode and a rolling shutter mode by an image sensor 100 to generate an image with a reduced rolling shutter effect.

In the present specification, global shutter image data may be image data output by the image sensor 100 operating in the global shutter mode. Rolling shutter image data may be image data output by the image sensor 100 operating in the rolling shutter mode.

The imaging apparatus 10 may include the image sensor 100 and a processor 200.

The image sensor 100 according to one or more embodiments may operate in one of the global shutter mode or the rolling shutter mode. In one or more embodiments, the image sensor 100 may alternately operate in the global shutter mode and the rolling shutter mode based on one command CMD of the processor 200.

For example, the image sensor 100 may operate in the rolling shutter mode based on a first command from the processor 200 that instructs capturing a still image and output at least one frame of rolling shutter image data IDT1, and then operate in the global shutter mode again to output at least one frame of global shutter image data IDT2. As another example, the image sensor 100, in an opposite order, may output at least one frame of the global shutter image data IDT2 first, and then switch to output at least one frame of the rolling shutter image data IDT1.

As another example, for example, the image sensor 100 may operate in the rolling shutter mode based on a second command from the processor 200 that instructs to capture a video and output at least one frame of the rolling shutter image data IDT1, and then operate in the global shutter mode again to output at least one frame of the global shutter image data IDT2.

The image sensor 100 may directly or indirectly transmit the rolling shutter image data IDT1 and the global shutter image data IDT2 to the processor 200. For example, the image sensor 100 may directly transmit the image data to the processor 200 through a communication line connected to the processor 200, or may transmit the image data to a separate interface device. The image data transmitted to the separate interface device may be stored in a memory device, and the processor 200 may load the image data from the memory device and process the image data.

The image sensor 100 may generate the rolling shutter image data IDT1 and the global shutter image data IDT2 based on the same pixels. For example, at least one pixel may operate in the rolling shutter mode to output a pixel signal for generating the rolling shutter image data IDT1 and operate in the global shutter mode to output a pixel signal for generating the global shutter image data IDT2.

In one or more embodiments, the rolling shutter image data IDT1 may include meta information indicating that rolling shutter image data IDT1 was captured in the rolling shutter mode. The global shutter image data IDT2 may include meta information indicating that global shutter image data IDT2 was captured in the global shutter mode. Therefore, the processor 200 may verify whether the received image data is the rolling shutter image data IDT1 or the global shutter image data IDT2.

The processor 200 may process the rolling shutter image data IDT1 and the global shutter image data IDT2 output by the image sensor 100 and generate image data IDT3 as a result of the processing. In one or more embodiments, the processor 200 may synthesize the rolling shutter image data IDT1 and the global shutter image data IDT2, and generate the image data IDT3 as a result of the synthesis.

According to one or more embodiments, synthesizing a plurality of image data may refer to generating at least one pixel data of synthesized image data using information of one image data and information of another image data. The image data may include a plurality of pixel data. In order to generate the pixel data, the processor 200 may determine a pixel value of the pixel data of synthesized image data using at least one image data among the plurality of image data. As another example, the processor 200 may determine a pixel location of the pixel data of synthesized image data using at least one image data among the plurality of image data. The pixel location may be a location of pixel data in an image frame and/or an order of pixel data in the image data.

The imaging apparatus 10 according to one or more embodiments may synthesize the rolling shutter image data IDT1 and the global shutter image data IDT2 output by the same image sensor 100. The synthesized image data IDT3 may have a reduced rolling shutter effect compared to the rolling shutter image data IDT1. In addition, the synthesized image data IDT3 may have reduced noise compared to the global shutter image data IDT2. Therefore, the imaging apparatus 10 may output image data with improved quality.

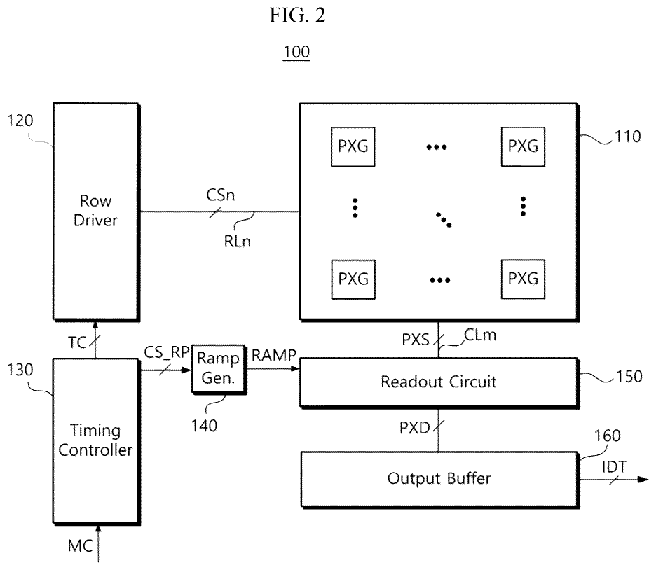

FIG. 2 is a block diagram exemplarily showing the image sensor 100 according to one or more embodiments.

The image sensor 100 according to one or more embodiments may operate in one a global shutter mode or a rolling shutter mode based on a shooting mode control signal MC.

In one or more embodiments, each pixel group PXG of the image sensor 100 may output a pixel signal in each of the global shutter mode and the rolling shutter mode. Each pixel group PXG may separately include a rolling shutter circuit for outputting the pixel signal to an output line in the rolling shutter mode and a global shutter circuit for outputting the pixel signal to the output line in the global shutter mode.

In one or more embodiments, each pixel group PXG may include a plurality of pixels, and at least some among the plurality of pixels may share a pixel circuit.

In one or more embodiments, among the output lines connected to each pixel group PXG of the image sensor 100, the output line through which the pixel signal is output in the rolling shutter mode and the output line through which the pixel signal is output in the global shutter mode may differ.

Referring to FIG. 2, the image sensor 100 will be described in detail.

The image sensor 100 may generate image data which is visual information of an object captured through a lens, and an image signal processor may be implemented to process the image data generated by the image sensor 100 and output it to a display device or store it on a storage device.

The image sensor 100 may include a pixel array 110, a row driver 120, a timing controller 130, a ramp signal generator 140, a readout circuit 150, and an output buffer 160.

The pixel array 110 may include a plurality of pixel groups PXG. The pixel array 110 may receive a plurality of pixel driving signals CSn, such as a selection signal that controls a selection transistor, a reset signal that controls a reset transistor, and a transfer transistor control signal that controls a transfer transistor, through row lines RLn from the row driver 120. Each of the plurality of pixels PXs of the pixel array 110 may operate according to the control of the received pixel driving signals CSn.

The plurality of pixel groups PXG may be arranged in, for example, a matrix form. Each pixel group PXG may be electrically connected to at least one row line and at least one column line among a plurality of row lines RWn and a plurality of column lines CLm. In one or more embodiments, each pixel group PXG may include a plurality of transistors controlled by the row driver 120.

In one or more embodiments, each pixel group PXG may include a plurality of pixels, and at least some among the plurality of pixels may share a pixel circuit.

The pixel group PXG may include at least one photoelectric conversion element that converts an incident light signal into an electrical signal. The pixel group PXG may include at least one photoelectric conversion element.

The photoelectric conversion element may be a photodiode (PD). The photoelectric conversion element may be one of a photodiode (PD), a photocapacitor, a photogate, a pinned photodiode (PPD), a partially pinned photodiode, an organic photo diode (OPD) and a quantum dot (QD) or a combination thereof. Embodiments of the present disclosure will be described on the assumption that the photoelectric conversion element is the PD, but the above-mentioned other photoelectric conversion elements may be used and the photoelectric conversion element is not limited to the PD.

The row driver 120 may drive the pixel group PXG arranged in one row of the pixel array 110 or the pixel groups PXG arranged in a plurality of rows according to the control of the timing controller 130.

Pixel signals PXS of the pixel groups PXG may be transmitted to the readout circuit 150 through a plurality of column lines CLm.

The pixel signal PXS may include a reset voltage signal and a pixel voltage signal. The pixel voltage signal may be a voltage of a floating diffusion region that reflects charge generated from the PD included in each of the plurality of pixels. The reset voltage signal may be a voltage of the floating diffusion region used as a reference voltage for performing correlated double sampling (CDS) with the pixel voltage signal.

The timing controller 130 may control the pixel array 110, the row driver 120, the ramp signal generator 140, and the readout circuit 150. The timing controller 130 may provide a timing control signal TC to the row driver 120.

The timing control signal TC according to one or more embodiments may be set differently based on a shooting mode control signal MC. For example, the shooting mode control signal MC is a signal based on a shooting mode selected by a user, and the shooting mode may include a still image mode, a video mode, etc. The shooting mode control signal MC may be a signal that controls the image sensor 100 to operate in the global shutter mode or the rolling shutter mode.

In one or more embodiments, the timing controller 130 may directly or indirectly receive the shooting mode control signal MC from the processor 200 of FIG. 1.

The row driver 120 may operate each of the plurality of pixel groups PXG in the global shutter mode or the rolling shutter mode based on the timing control signal TC.

In one or more embodiments, when the row driver 120 drives each of the plurality of pixel groups PXG in the rolling shutter mode, the row driver 120 may operate the pixel groups PXG to provide a plurality of conversion gain modes.

The timing controller 130 may control the ramp signal generator 140 through a ramp control signal CS_RP and control the readout circuit 150 through a ADC control signal CS_ADC. The lamp control signal CS_RP may include a lamp enable signal, a mode signal, etc.

The ramp signal generator 140 may generate a ramp signal RAMP in response to the ramp control signal CS_RP. The ramp signal generator 140 may generate the ramp signal RAMP having a preset slope. The ramp signal generator 140 may provide the generated ramp signal RAMP to the readout circuit 150.

The readout circuit 150 may, based on the ramp signal RAMP, convert the reset voltage signal and the pixel voltage signal of the pixel signal PXS into pixel data PXD which is a digital signal and output the converted pixel data PXD. For example, the readout circuit 150 may convert each of the reset voltage signal and the pixel voltage signal into a digital signal based on the ramp signal RAMP using a correlated double sampling method, and output the difference between the reset voltage signal and the pixel voltage signal as the pixel data PXD which is the digital signal.

The readout circuit 150 may include a comparator and a counting circuit. The pixel signal PXS and the ramp signal RAMP may be provided to the comparator. The counting circuit may count a clock signal corresponding to a level of the reset voltage signal and a level of the pixel voltage signal. The counting circuit may generate the difference between the level of the reset voltage signal and the level of the pixel voltage signal as the pixel data PXD which is the digital signal.

The output buffer 160 may include a plurality of column memory blocks corresponding to each column to store the pixel data PXD. The output buffer 160 may include a sense amplifier SA for amplifying the pixel data PXD stored in the column memory block. The sense amplifier SA may output the amplified pixel data PXD as image data IDT.

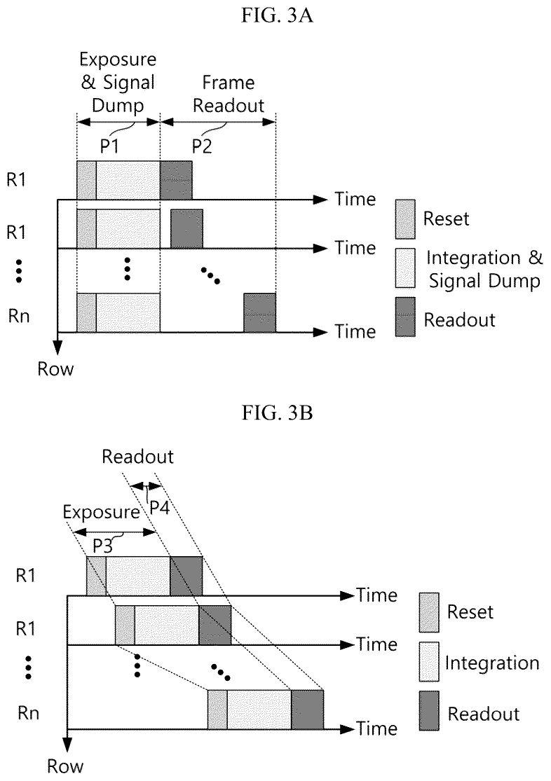

FIG. 3A is a diagram showing an operation of the global shutter mode of the image sensor 100 of FIG. 1. FIG. 3B is a timing diagram showing an operation of the rolling shutter mode of the image sensor 100 of FIG. 1.

Referring to FIGS. 1 and 3A, when operating in global shutter mode, the image sensor 100 may control each pixel group PXG so that a photocharge integration time P1 of the PD is located in the same time section for all pixels of the pixel array 110. The photocharge integration time may refer to a time during which the PD substantially integrates a photocharge. The image sensor 100 may perform a signal-dump operation in the photocharge integration time P1.

In one or more embodiments, the time required to readout all pixel groups PXG of the pixel array 110 of FIG. 2 corresponding to one frame of image signals may be a frame readout time P2.

In one or more embodiments, in the global shutter mode, the image sensor 100 may perform a rolling readout operation. For example, the image sensor 100 may control each pixel group PXG so that the time section during which readout is performed after the integration time differs for each row R1, R2, . . . , Rn of the pixel array. As another example, the time section during which the readout is performed may differ for rows of a certain group. In this case, the readout for the pixel groups PXG disposed in rows of the same group may be performed in the same time section.

Referring to FIGS. 1 and 3B, when the image sensor 100 operates in rolling shutter mode, the image sensor 100 may control each pixel group PXG so that the time section in which a photocharge integration time P3 of the PD is located differs for each row R1, R2, . . . , Rn of the pixel array. In one or more embodiments, the time section during which integration of the photocharge is performed may differ for each row R1, R2, . . . , Rn. As another example, the time section during which the integration of the photocharge is performed may differ for rows of a certain group. In this case, the integration of the photocharge for the pixel groups PXG disposed in rows of the same group may be performed in the same time section.

In one or more embodiments, in the rolling shutter mode, the image sensor 100 may perform the rolling readout operation. For example, the image sensor 100 may control each pixel group PXG so that a time section P4 during which the readout is performed after the integration time differs for each row R1, R2, . . . , Rn of the pixel array. As another example, the time section during which the readout is performed may differ for rows of a certain group. In this case, the readout for the pixel groups PXG disposed in rows of the same group may be performed in the same time section.

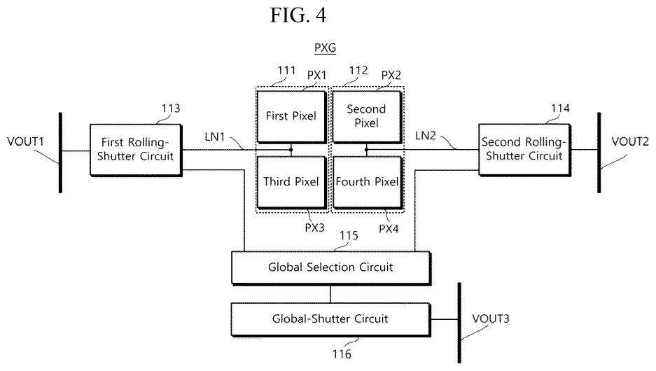

FIG. 4 is a block diagram of a pixel group PXG according to one or more embodiments. The pixel group PXG described with reference to FIG. 4 may correspond to the pixel group PXG in FIG. 1. The pixel group PXG according to one or more embodiments will be described with reference to FIG. 4.

Referring to FIG. 4, the pixel group PXG according to one or more embodiments may include a plurality of pixels PX1, PX2, PX3, and PX4, a first rolling-shutter circuit 113, a second rolling-shutter circuit 114, a global selection circuit 115, and a global-shutter circuit 116. FIG. 4 shows that the pixel group PXG includes four pixels PX1, PX2, PX3, and PX4, but the present invention is not limited thereto, and the pixel group PXG may include a different number of pixels.

In one or more embodiments, at least some of the plurality of pixels PX1, PX2, PX3, and PX4 may share at least some of the pixel circuits.

For example, referring to FIG. 4, the plurality of pixels PX1, PX2, PX3, and PX4 may share the global selection circuit 115 and the global-shutter circuit 116. A first pixel PX1 and a third pixel PX3 may share the first rolling-shutter circuit 113. A second pixel PX2 and a fourth pixel PX4 may share the second rolling-shutter circuit 114.

In one or more embodiments, each of the plurality of pixels PX1, PX2, PX3, and PX4 may include at least one PD.

In one or more embodiments, at least some of the pixels PX1, PX2, PX3, and PX4 may simultaneously operate in the global shutter mode or the rolling shutter mode.

For example, in the rolling shutter mode, the first pixel PX1 and the third pixel PX3 may be simultaneously controlled as one sub-pixel group 111. The first pixel PX1 and the third pixel PX3 may transmit integrated photocharges to the first rolling-shutter circuit 113 through a first line LN1 during the same time. In addition, the second pixel PX2 and the fourth pixel PX4 may be simultaneously controlled as another sub-pixel group 112. The second pixel PX2 and the fourth pixel PX4 may transmit integrated photocharges to the second rolling-shutter circuit 114 through a second line LN2 by the same control signal during the same time. The first line LN1 and the second line LN2 may be a metal wiring.

For example, in the rolling shutter mode, each of the pixels PX1, PX2, PX3, and PX4 may be each controlled. The first pixel PX1 and the second pixel PX2 may be simultaneously controlled by different rolling-shutter circuits 113 and 114, respectively. The first pixel PX1 and the second pixel PX2 may transmit the integrated photocharges to the first rolling-shutter circuit 113 and the second rolling-shutter circuit 114 through the first line LN1 and the second line LN2 during the same first time. Similarly, the third pixel PX3 and the fourth pixel PX4 may be simultaneously controlled by different rolling-shutter circuits 113 and 114, respectively. The third pixel PX3 and the fourth pixel PX4 may transmit the integrated photocharges to the first rolling-shutter circuit 113 and the second rolling-shutter circuit 114 through the first line LN1 and the second line LN2 during the same second time.

For example, in a binning mode of the rolling shutter mode, all of the pixels PX1, PX2, PX3, and PX4 may transmit the integrated photocharges to the first rolling-shutter circuit 113 and the second rolling-shutter circuit 114 through the first line LN1 and the second line LN2 during the same time. The first rolling-shutter circuit 113 and the second rolling-shutter circuit 114 may output the pixel signals through different output lines VOUT1 and VOUT2, respectively, but the readout circuit 150 of FIG. 2 may integrate the pixel signals output through the different output lines VOUT1 and VOUT2 to output the image data.

For example, in the global shutter mode, all of the pixels PX1, PX2, PX3, and PX4 may be simultaneously controlled. The pixels PX1, PX2, PX3, and PX4 may transmit the integrated photocharges to the first rolling-shutter circuit 113 or the second rolling-shutter circuit 114 by the same control signal during the same time. The pixel signals based on the photocharges generated in the pixels PX1, PX2, PX3, and PX4 may all be transmitted to the global-shutter circuit 116 during the same time.

The pixel group PXG according to one or more embodiments described with reference to FIG. 2 may transmit an optical signal to the same rolling-shutter circuits 113 and 114 through the same lines LN1 and LN2 by dividing the plurality of pixels PX1, PX2, PX3, and PX4 into the even number of pixels and output the signal to a plurality of output lines VOUT1 and VOUT2. Therefore, the pixel group PXG may simultaneously readout the pixel signals of the plurality of pixels in the rolling shutter mode. In addition, since the transfer transistors of the pixels controlled identically during the same time may use the same transfer transistor control signal, the number of metal wirings for transmitting the transfer transistor control signal may be reduced. As a result, the process may be more simplified, and parasitic capacitance due to the metal wirings may be reduced. In addition, the image sensor 100 of FIG. 1 may drive the plurality of pixels PX1, PX2, PX3, and PX4 in various operation methods in the rolling shutter mode. Therefore, the image sensor 100 may perform various functions of the rolling shutter mode.

Furthermore, since the global-shutter circuit 116 is separated from the rolling-shutter circuits 113 and 114 through the global selection circuit 115, the global-shutter circuit 116 may more easily operate in the global mode.

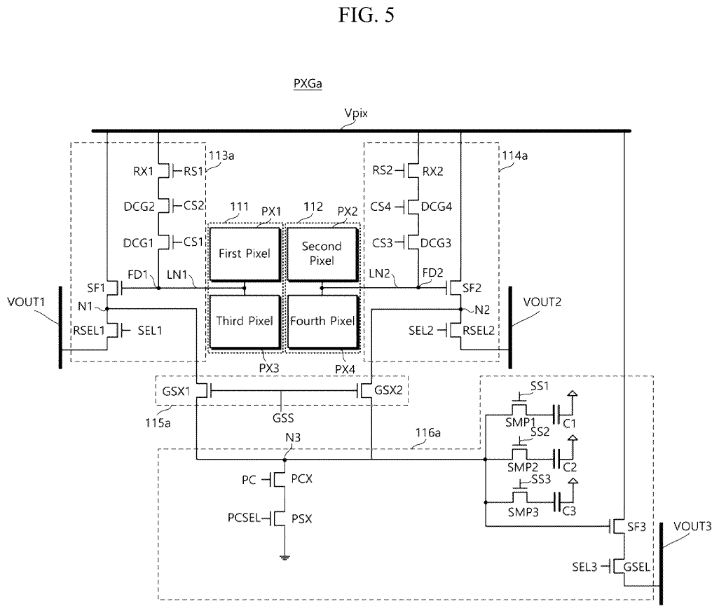

FIG. 5 is a circuit diagram of a pixel group according to one or more embodiments. The circuit of FIG. 5 may correspond to the pixel group PXG of FIG. 4. A circuit configuration according to one or more embodiments of the pixel group PXG will be described with reference to FIG. 5. Referring to FIG. 4, a detailed description of overlapping or similar parts will be omitted.

Referring to FIG. 5, a pixel group PXGa according to one or more embodiments may include a plurality of pixels PX1, PX2, PX3, and PX4, a first rolling-shutter circuit 113a, a second rolling-shutter circuit 114a, a global selection circuit 115a, and a global-shutter circuit 116a. FIG. 5 shows that the pixel group PXGa includes four pixels PX1, PX2, PX3, and PX4, but the present invention is not limited thereto, and the pixel group PXGa may include a different number of pixels.

The first rolling-shutter circuit 113a will be described with reference to FIG. 5. The second rolling-shutter circuit 114a may operate in a manner similar to the first rolling-shutter circuit 113a through the same operation as the corresponding transistors in the first rolling-shutter circuit 113a.

The first pixel PX1 and the third pixel PX3 may be connected to a first floating diffusion region FD1 through a same first line. The first floating diffusion region FD1 may be connected to a pixel voltage electrode Vpix through a first reset transistor RX1.

In one or more embodiments, at least one conversion gain control transistors DCG1 and DCG2 between the first reset transistor RX1 and the first floating diffusion region FD1 may be connected in series. Each of the conversion gain control transistors DCG1 and DCG2 may be turned-on or turned-off by conversion gain control signals CS1 and CS2. When the conversion gain control transistors DCG1 and DCG2 are turned-on, the capacitance of the first floating diffusion region FD1 may increase and the conversion gain may decrease. Therefore, the first pixel PX1 and the third pixel PX3 may operate in a low conversion gain (LCG) mode. Conversely, when the conversion gain control transistors DCG1 and DCG2 are turned-off, the capacitance of the first floating diffusion region FD1 may increase and the conversion gain may increase. Therefore, the first pixel PX1 and the third pixel PX3 may operate in a high conversion gain (HCG) mode.

A pixel voltage or a reset voltage of the first floating diffusion region FD1 may be converted into a pixel signal of the rolling shutter mode by a first source follower transistor SF1 and output to a first output line VOUT1 through a first node N1 and a first selection transistor SEL1. In the rolling shutter mode, global selection transistors GSX1 and GSX2 of the global selection circuit 115a may be turned-off by the global selection signal GSS.

The global selection circuit 115a may connect a third node N3 of the global-shutter circuit 116a to each of the first node N1 and a second node N2. The first node N1 is a node between the first source follower transistor SF1 and the first selection transistor SEL1 of the first rolling-shutter circuit 113a, and the second node N2 is a node between a second source follower transistor SF2 and a second selection transistor SEL2 of the second rolling-shutter circuit 114a.

In the global shutter mode, a first global selection transistor GSX1 may be turned-on, and the pixel signals of the first pixel PX1 and the third pixel PX3 may be stored in one of a first capacitor C1, a second capacitor C2, and a third capacitor C3 via the first node N1 and the third node N3. Similarly, a second global selection transistor GSX2 may be turned-on, and the pixel signals of the second pixel PX2 and the fourth pixel PX4 may be stored in one of the first capacitor C1, the second capacitor C2, and the third capacitor C3 through the second node N2 and the third node N3. The first global selection transistor GSX1 and the second global selection transistor GSX2 may be simultaneously turned-on or turned-off by the global selection signal GSS. Therefore, the pixel signals of the pixels PX1, PX2, PX3, and PX4 may be stored in the same capacitor of one among the first capacitor C1, the second capacitor C2, and the third capacitor C3.

One terminals of the first capacitor C1, the second capacitor C2, and the third capacitor C3 may be connected to a first sampling transistor SMP1, a second sampling transistor SMP2, and a third sampling transistor SMP3, respectively. Each of the other terminals of the first capacitor C1, the second capacitor C2, and the third capacitor C3 may be connected to the pixel voltage electrode VPIX. The first sampling transistor SMP1, the second sampling transistor SMP2, and the third sampling transistor SMP3 may be controlled by a first sampling control signal SS1, a second sampling control signal SS2, and a third sampling control signal SS3, respectively.

In one or more embodiments, the first capacitor C1 may store the reset voltage signals of the first floating diffusion region FD1 and a second floating diffusion region FD2 by the control of the first sampling transistor SMP1. The second capacitor C2 may store auto-focus signals of the pixels PX1, PX2, PX3, and PX4 by the control of the second sampling transistor SMP2. For example, each of the pixels PX1, PX2, PX3, and PX4 may include a first photodiode located at one side and a second photodiode located at the other side. The auto-focus signal may be the pixel voltage signal based on the photocharges of the first photodiodes or the second photodiodes of the pixels PX1, PX2, PX3, and PX4. The third capacitor C3 may store the pixel voltage signals based on all the photodiodes of the pixels PX1, PX2, PX3, and PX4 by the control of the third sampling transistor SMP3.

In one or more embodiments, each of the pixel signals stored in the first capacitor C1, the second capacitor C2, and the third capacitor C3 may be output through a third output line VOUT3 at different readout times.

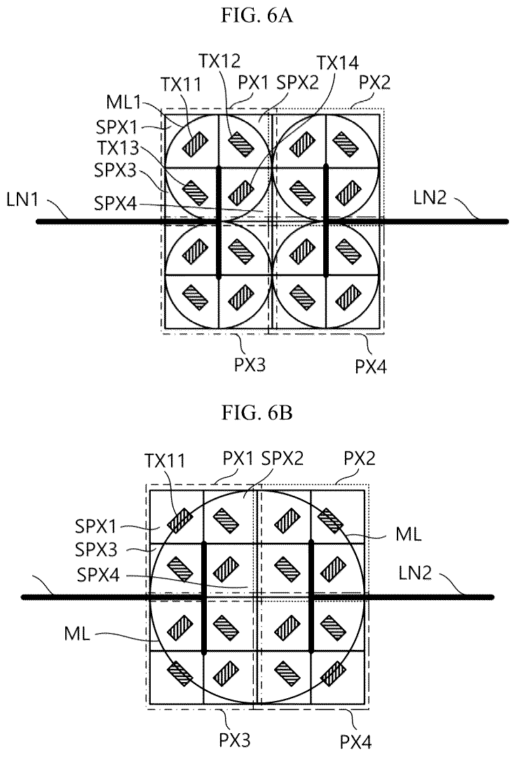

FIGS. 6A and 6B are diagrams describing sub-pixels SPX1, SPX2, SPX3, and SPX4 according to one or more embodiments. Each of the pixels PX1, PX2, PX3, and PX4 described with reference to FIGS. 4 and 5 may be configured based on the sub-pixels SPX1, SPX2, SPX3, and SPX4 of FIG. 6A or 6B. The pixels PX1, PX2, PX3, and PX4 of FIGS. 6A and 6B may correspond to the pixels PX1, PX2, PX3, and PX4 of FIGS. 4 and 5. The pixels PX1, PX2, PX3, and PX4 may have a similar structure. Therefore, the first pixel PX1 will be exemplarily described with reference to FIGS. 6A and 6B.

In one or more embodiments, referring to FIGS. 6A and 6B, the first pixel PX1 may include a plurality of sub-pixels SPX1, SPX2, SPX3, and SPX4. Each of the sub-pixels SPX1, SPX2, SPX3, and SPX4 may include a photodiode. The sub-pixels SPX1, SPX2, SPX3, and SPX4 may include transfer transistors TX11, TX12, TX13, and TX14, respectively. Each of the sub-pixels SPX1, SPX2, SPX3, and SPX4 may transmit a photocharge of the photodiode to a floating diffusion region through the transfer transistors TX11, TX12, TX13, and TX14 and lines LN1 and LN2.

In one or more embodiments, referring to FIG. 6A, the plurality of sub-pixels SPX1, SPX2, SPX3, and SPX4 located in the same pixel may share one microlens. For example, the plurality of sub-pixels SPX1, SPX2, SPX3, and SPX4 of the first pixel PX1 may share a first microlens ML1. Therefore, each of the pixels PX1, PX2, PX3, and PX4 may include an individual microlens.

In one or more embodiments, referring to FIG. 6B, the pixels PX1, PX2, PX3, and PX4 may share one microlens ML. Therefore, a pixel group may include one microlens ML.

In one or more embodiments, a color filter that transmits light of the same spectrum may be disposed in the pixels PX1, PX2, PX3, and PX4 of FIGS. 6A and 6B.

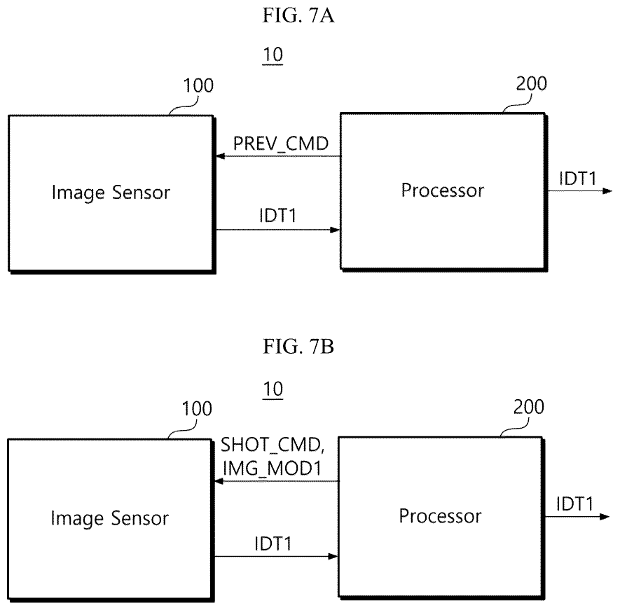

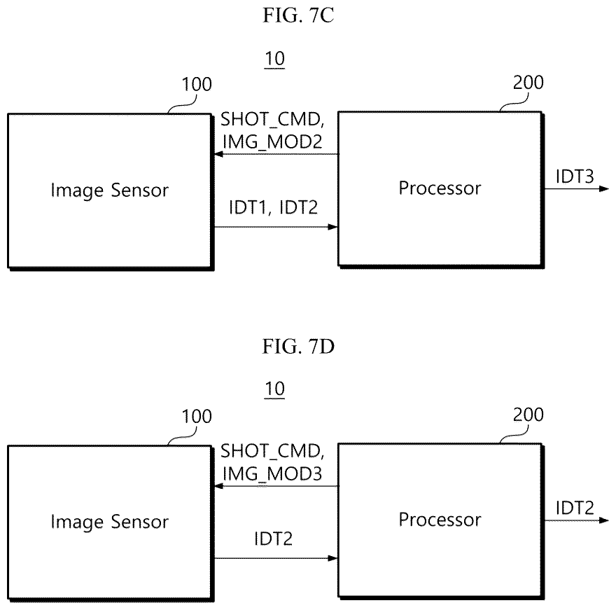

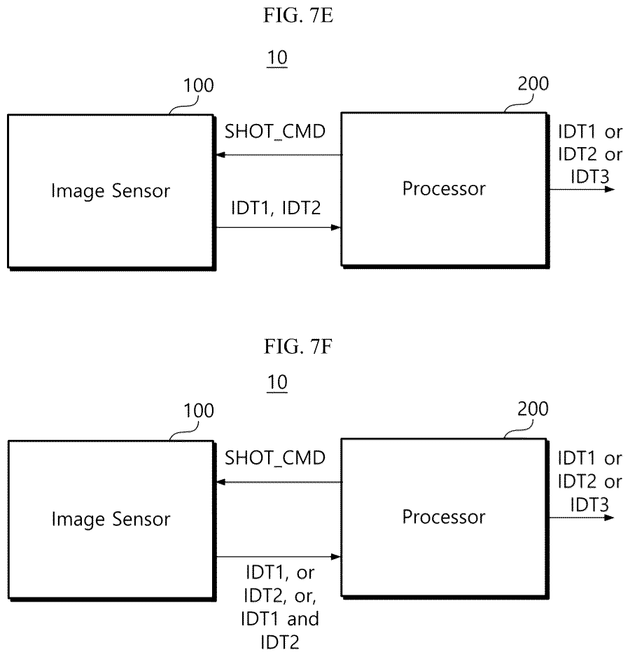

FIGS. 7A to 7F are diagrams describing operations according to shooting modes of an imaging apparatus 10 according to one or more embodiments. The imaging apparatus 10 described with reference to FIGS. 7A to 7F may correspond to the imaging apparatus 10 of FIG. 1. An image sensor 100 and a processor 200 of the imaging apparatus 10 according to the one or more embodiments of FIGS. 7A to 7F may correspond to the image sensor 100 and the processor 200 of FIGS. 1 and 2.

In the one or more embodiments described with reference to FIGS. 7A to 7F, a first image data IDT1 may be image data output by the image sensor 100 in a rolling shutter mode, and a second image data IDT2 may be image data output by the image sensor 100 in a global shutter mode. Third image data IDT3 may be image data synthesized by the processor 200 from the first image data IDT1 and the second image data IDT2.

Referring to FIG. 7A, in one or more embodiments, the processor 200 may transmit a preview command PREV_CMD to the image sensor 100. The image sensor 100 may output the first image data IDT1 captured in the rolling shutter mode in response to the preview command PREV_CMD received from the processor 200. The processor 200 may control a display device to display the first image data IDT1 on the display device.

For example, the image sensor 100 may operate only in the rolling shutter mode in a preview mode and output the first image data IDT1. The imaging apparatus 10 may display the first image data IDT1 output by the image sensor 100 in the rolling shutter mode on the display device without performing synthesis of the first image data IDT1 and the second image data IDT2 in the preview mode.

Referring to FIGS. 7B to 7D, in one or more embodiments, the processor 200 may transmit a shooting command SHOT_CMD and a mode control command to the image sensor 100. The shooting command SHOT_CMD may be a command that instructs to capture a still image or a video. The mode control command may be one of a plurality of mode control commands. For example, referring to FIGS. 7B to 7D, the plurality of mode control commands may include a first mode control command IMG_MOD1, a second mode control command IMG_MOD2, and a third mode control command IMG_MOD3.

In one or more embodiments, the plurality of mode control commands may be commands that instruct image data output by the image sensor 100 among the first image data IDT1 and the second image data IDT2. The plurality of mode control commands may be commands that instruct an operation mode of the image sensor 100.

For example, referring to FIG. 7B, the first mode control command IMG_MOD1 may be a command that the processor 200 instructs the image sensor 100 to output the first image data IDT1. The first mode control command IMG_MOD1 may be a command that the processor 200 instructs the image sensor 100 to operate in the rolling shutter mode.

For example, referring to FIG. 7C, the second mode control command IMG_MOD2 may be a command that the processor 200 instructs the image sensor 100 to output both the first image data IDT1 and the second image data IDT2. The second mode control command IMG_MOD2 may be a command that the processor 200 instructs the image sensor 100 to alternately operate in the rolling shutter mode and the global shutter mode.

Continuing with reference to FIG. 7C, the image sensor 100 may alternately operate in the rolling shutter mode and the global shutter mode in response to the second mode control command IMG_MOD2 and alternately output at least one frame of the first image data IDT1 and at least one frame of the second image data IDT2. For example, when the shooting command SHOT_CMD is a command that instructs to capture a video, the image sensor 100 may repeat the output of one frame of the first image data IDT1 and the output of one frame of the second image data IDT2. As another example, the image sensor 100 may repeat the output of one frame of the first image data IDT1 and the output of two frames of the second image data IDT2. As another example, the image sensor 100 may repeat the output of two frames of the first image data IDT1 and the output of one frame of the second image data IDT2.

For example, referring to FIG. 7D, the third mode control command IMG_MOD3 may be a command that the processor 200 instructs the image sensor 100 to output the second image data IDT2. The third mode control command IMG_MOD3 may be a command that the processor 200 instructs the image sensor 100 to operate in the global shutter mode. In one or more embodiments, the processor 200 may transmit one mode control command among the first mode control command IMG_MOD1, the second mode control command IMG_MOD2, and the third mode control command IMG_MOD3 to the image sensor 100 based on an illumination of shooting environment.

For example, when the illumination of the shooting environment is smaller than a preset first reference illumination, the processor 200 may transmit the first mode control command IMG_MOD1 to the image sensor 100. When the illumination of the shooting environment is greater than the preset first reference illumination and lower than a preset second reference illumination, the processor 200 may transmit the second mode control command IMG_MOD2 to the image sensor 100. When the illumination of the shooting environment is greater than the preset second reference illumination, the processor 200 may transmit the third mode control command IMG_MOD3 to the image sensor 100.

Referring to FIGS. 7B to 7D, in one or more embodiments, the processor 200 may not perform synthesis of the image data in response to the first mode control command IMG_MOD1 and the third mode control command IMG_MOD3. The processor 200 may synthesize the first image data IDT1 and the second image data IDT2 in response to the second mode control command IMG_MOD2 and output the third image data IDT3 as a result of the synthesis.

Referring to FIG. 7E, in one or more embodiments, the processor 200 may transmit the shooting command SHOT_CMD to the image sensor 100 without transmitting the mode control command. The image sensor 100 may alternately operate in the rolling shutter mode and the global shutter mode in response to the shooting command SHOT_CMD, and output the first image data IDT1 and the second image data IDT2.

For example, referring to FIG. 7E, the image sensor 100 may always output the first image data IDT1 and the second image data IDT2 in response to the shooting command SHOT_CMD received from the processor 200. The processor 200 may determine whether to synthesize the first image data IDT1 and the second image data IDT2 based on the shooting environment or preset conditions.

For example, based on the illumination of the shooting environment, the processor may determine to synthesize the first image data IDT1 and the second image data IDT2, determine the first image data IDT1 as the final image data, or determine the second image data IDT2 as the final image data.

As another example, the processor 200 may perform scene analysis of the first image data IDT1 or the second image data IDT2 and, based on the type of the recognized scene, determine the first image data IDT1 or the second image data IDT2 as the final image data or determine to synthesize the first image data IDT1 and the second image data IDT2.

In one or more embodiments, referring to FIG. 7F, the processor 200 may transmit the shooting command SHOT_CMD without transmitting the mode control command to the image sensor 100. In this case, the image sensor 100 may determine whether to output at least one of the first image data IDT1 or the second image data IDT2 based on the shooting environment or the preset conditions.

For example, the image sensor 100 may include an illumination sensor or determine whether to output at least one of the first image data IDT1 and the second image data IDT2 based on illumination information received from the processor 200.

For another example, the image sensor 100 may operate in the rolling shutter mode to generate the first image data IDT1, perform the scene analysis of the first image data IDT1, and, based on the type of the recognized scene, determine whether to additionally output the second image data IDT2 by operating in the global shutter mode. In this case, the image sensor 100 may further include a logic circuit that performs the scene analysis based on a neural network. In addition, the image sensor 100 may optionally include a memory circuit and/or a digital signal processing logic circuit for performing operations of the logic circuit. In one or more embodiments, when the image sensor 100 performs the scene analysis of the first image data IDT1, the image sensor 100 may output the result of the scene analysis separately from the image data.

Therefore, referring back to FIG. 7F, the image sensor 100 may operate in the rolling shutter mode in response to the shooting command SHOT_CMD and output the first image data IDT1. As another example, the image sensor 100 may alternately operate in the rolling shutter mode and the global shutter mode in response to the shooting command SHOT_CMD and output the first image data IDT1 and the second image data IDT2. As another example, the image sensor 100 may operate in the global shutter mode in response to the shooting command SHOT_CMD and output the second image data IDT2.

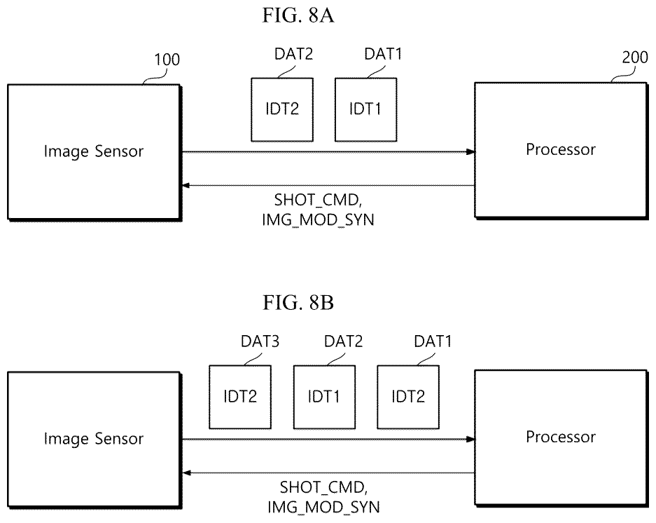

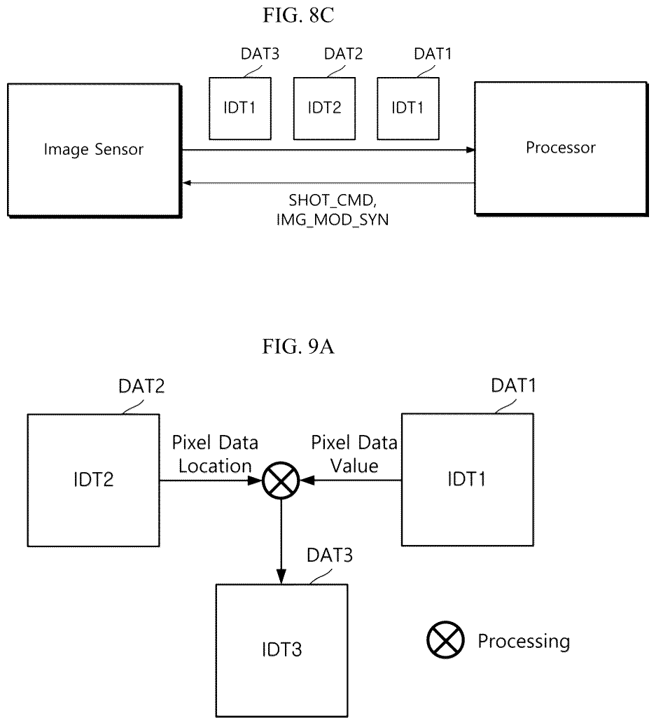

FIGS. 8A to 8C are diagrams describing image data used for synthesis when an imaging apparatus according to one or more embodiments performs the synthesis of the image data.

In the one or more embodiments of FIGS. 8A to 8C, the image sensor 100 may alternately operate in the rolling shutter mode and the global shutter mode in response to the mode control command IMG_MOD_SYN. FIGS. 8A to 8C show the image data output by the image sensor 100 according to the one or more embodiments. The output image data may be directly or indirectly transmitted to the processor 200, and the processor 200 may use the image data output by the image sensor 100 for the synthesis.

Referring to FIGS. 8A to 8C, in one or more embodiments, the processor 200 may transmit the shooting command SHOT_CMD and a mode control command IMG_MOD_SYN to the image sensor 100. The one or more embodiments described with reference to FIGS. 8A to 8C will be described on the assumption that the shooting command SHOT_CMD is a command for capturing a still image. However, even when the shooting command SHOT_CMD is a command for capturing a video, the image sensor 100 may operate in a manner of repeatedly performing the embodiments of FIGS. 8A to 8C.

The mode control command IMG_MOD_SYN may be a command that the processor 200 instructs the image sensor 100 to output both the first image data IDT1 and the second image data IDT2. The mode control command IMG_MOD_SYN may be a command that the processor 200 instructs the image sensor 100 to alternately operate in the rolling shutter mode and the global shutter mode.

In one or more embodiments, the mode control command IMG_MOD_SYN may correspond to the second mode control command IMG_MOD2 of FIG. 7C, but is not limited thereto. That is, the processor 200 may transmit the mode control command IMG_MOD_SYN to the image sensor 100 based on the illumination of the shooting environment. As another example, the processor may transmit the mode control command IMG_MOD_SYN to the image sensor 100 based on other preset conditions.

Referring to FIG. 8A, in one or more embodiments, the image sensor 100 may alternately operate in the rolling shutter mode and the global shutter mode in response to the mode control command IMG_MOD_SYN and alternately output one frame of the first image data IDT1 (DAT1) and one frame of the second image data IDT2 (DAT2). For example, the image sensor 100 may operate in the rolling shutter mode to output one frame of the first image data IDT1 (DAT1), and then operate in the global shutter mode again to output one frame of the second image data IDT2 (DAT2). The order of the output of the first image data IDT1 and the output of the second image data IDT2 is not particularly limited. The processor 200 may synthesize one frame of the first image data IDT1 (DAT1) and one frame of the second image data IDT2 (DAT2) and output the third image data.

Referring to FIG. 8B, in one or more embodiments, the image sensor 100 may alternately operate in the rolling shutter mode and the global shutter mode in response to the mode control command IMG_MOD_SYN and output one frame of the first image data IDT1 (DAT2) and two frames of the second image data IDT2 (DAT1 and DAT3). For example, the image sensor 100 may operate in the global shutter mode and output one frame of the second image data IDT2 (DAT1). Thereafter, the image sensor 100 may operate in the rolling shutter mode and output one frame of the first image data IDT1 (DAT2). The image sensor 100 may operate again in the global shutter mode and output one frame of the second image data IDT2 (DAT3). The processor 200 may synthesize one frame of the first image data IDT1 (DAT2) and two frames of the second image data IDT2 (DAT1 and DAT3) and output the third image data.

Referring to FIG. 8C, in one or more embodiments, the image sensor 100 may alternately operate in the rolling shutter mode and the global shutter mode in response to the mode control command IMG_MOD_SYN and output two frames of the first image data IDT1 (DAT1 and DAT3) and one frame of the second image data IDT2 (DAT2). For example, the image sensor 100 may operate in the rolling shutter mode and output one frame of the first image data IDT1 (DAT1). Thereafter, the image sensor 100 may operate in the global shutter mode and output one frame of the second image data IDT2 (DAT2). The image sensor 100 may again operate in the rolling shutter mode and output one frame of the first image data IDT1 (DAT3). The processor 200 may synthesize two frames of the first image data IDT1 (DAT1 and DAT3) and one frame of the second image data IDT2 (DAT2) and output the third image data.

The number of image data used by the processor 200 for synthesizing the image data is not limited to the one or more embodiments of FIGS. 8A to 8C. For example, the processor 200 may use more frames of the first image data IDT1 than those of the embodiments of FIGS. 8A to 8C, and/or more frames of the second image data IDT2 than those of the embodiments of FIGS. 8A to 8C for synthesis.

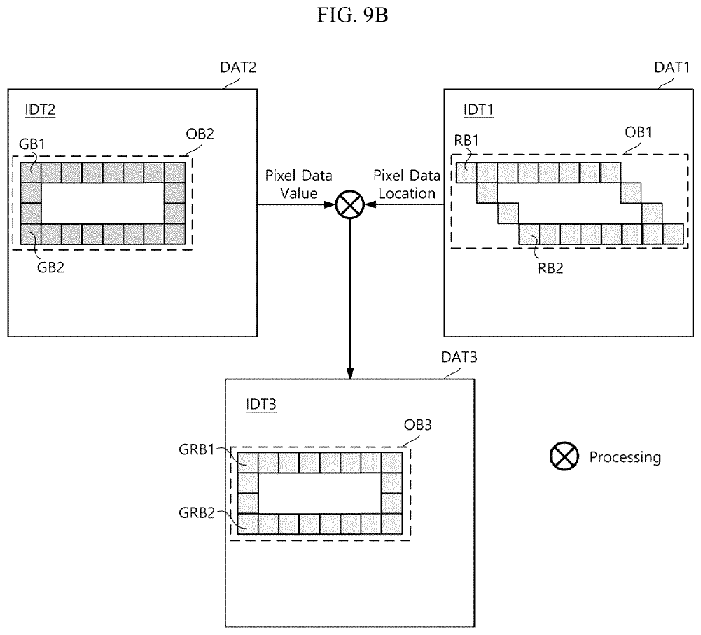

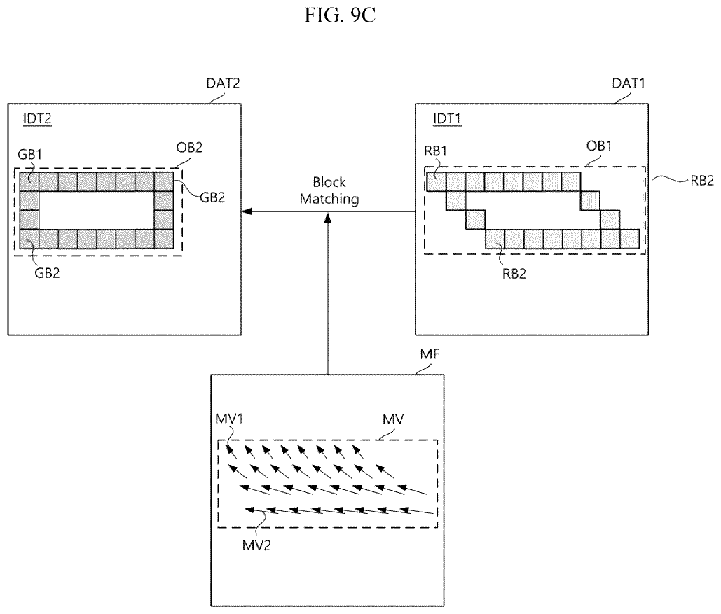

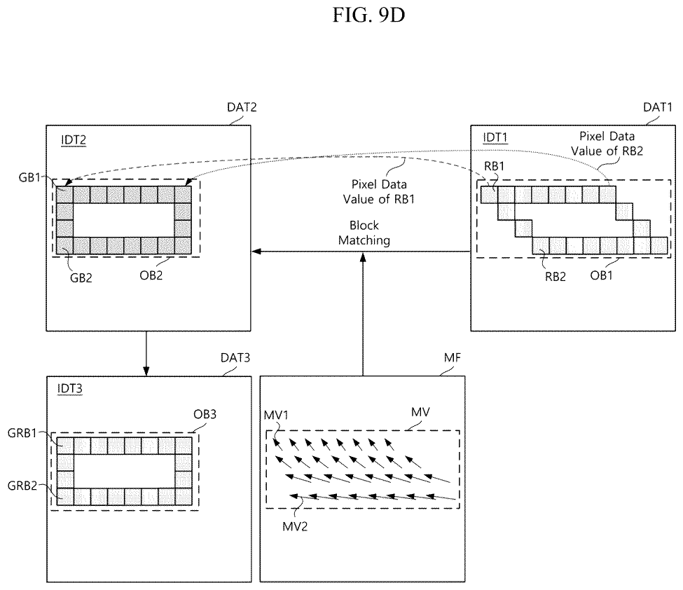

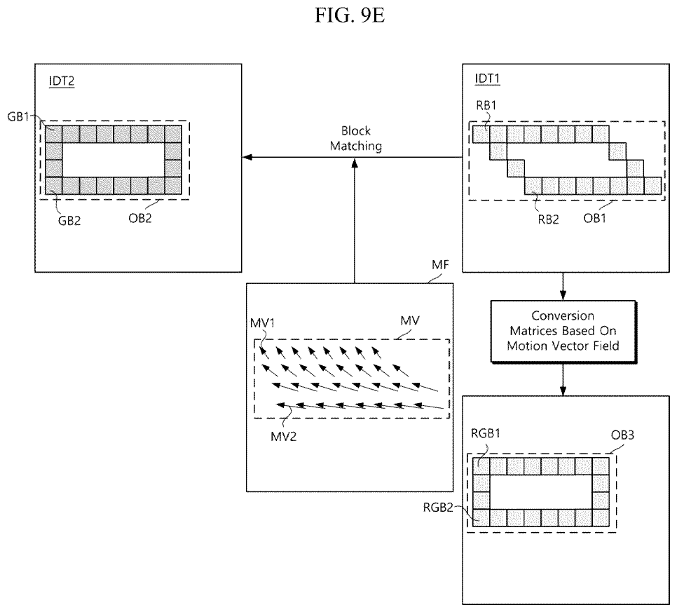

FIGS. 9A to 9E are diagrams describing operations in which the imaging apparatus 10 of FIG. 1 synthesizes the global shutter image data and the rolling shutter image data according to the embodiment of FIG. 8A. Referring to FIG. 8A and FIGS. 9A to 9E, methods in which he imaging apparatus 10 synthesizes one frame of the global shutter image data and one frame of the rolling shutter image data will be described. The methods of FIGS. 9A to 9E may be performed by the processor 200 of the imaging apparatus 10 of FIG. 1.

Referring to FIG. 9A, in one or more embodiments, the processor 200 of FIG. 8A may process one frame of the first image data IDT1 (DAT1) and one frame of the second image data IDT2 (DAT2) to output the third image data IDT3 (DAT3). The processing may refer to performing synthesis by the processor 200.

The image data may include a plurality of pixel data. The processor 200 may display the image data on a display device or perform processing of the image data based on a pixel location and a pixel value of each of the plurality of pixel data.

In one or more embodiments, the processor 200 may generate the third image data IDT3 based on the pixel value of at least one first pixel data of the first image data IDT1 and the pixel location of at least one second pixel data of the second image data IDT2. The processor 200 may use the pixel value of the first image data IDT1 captured in the rolling shutter mode and the pixel location of the second image data IDT2 captured in the global shutter mode to generate the third image data IDT3. Therefore, an image with reduced rolling shutter effect and noise may be generated.

For example, FIG. 9B shows a first object OB1 composed of a plurality of pixel blocks of the first image data IDT1 (DAT1), a second object OB2 composed of a plurality of pixel blocks of the second image data IDT2 (DAT2), and a third object OB3 composed of a plurality of pixel blocks of the third image data IDT3 (DAT3). Each pixel block may include at least one pixel data.

Referring to FIG. 9B, the pixel value of each pixel block of the third object OB3 of the third image data IDT3 (DAT3) output by the processor 200 of FIG. 8A may correspond to each pixel value of the first object OB1 of the first image data IDT1 (DAT1). In addition, the pixel location of each pixel block of the third object OB3 of the third image data IDT3 (DAT3) may correspond to each pixel location of the second object OB2 of the second image data IDT2 (DAT2).

For example, the pixel data constituting a first pixel block GRB1 of the third object OB3 may be generated based on the pixel value of the pixel data constituting a first pixel block RB1 of the first object OB1 and the pixel location of the pixel data constituting a first pixel block GB1 of the second object OB2. The pixel data constituting a second pixel block GRB2 of the third object OB3 may be generated based on the pixel value of the pixel data constituting a second pixel block RB2 of the first object OB1 and the pixel location of the pixel data constituting a second pixel block GB2 of the second object OB2.

In the present disclosure, generating the pixel block may be generating the pixel data constituting the pixel block. Determining the pixel location of the pixel block may be determining the pixel location of the pixel data constituting the pixel block, and determining the pixel value of the pixel block may be determining the pixel value of the pixel data constituting the pixel block.

Referring to FIG. 9C, the processor 200 of FIG. 8A may perform block matching between one frame of the first image data IDT1 (DAT1) and one frame of the second image data IDT2 (DAT2) and determine a corresponding relationship based on the block matching. For example, the processor 200 may determine a motion vector field MF based on the block matching. The processor 200 may perform the block matching using various conventional methods and determine the motion vector field MF.

In one or more embodiments, the processor 200 may perform the block matching and determine each of the pixel blocks of the second image data IDT2 (DAT2) corresponding to each of the pixel blocks of the first image data IDT1 (DAT1). The processor 200 may determine the motion vector field MF based on changes in locations of corresponding pixel blocks in the first image data IDT1 (DAT1) and the second image data IDT2 (DAT2). The motion vector field MF may include a plurality of motion vectors MV.

For example, the first pixel block RB1 of the first image data IDT1 (DAT1) which is the rolling shutter image data may correspond to the first pixel block GB1 of the second image data IDT2 (DAT2) which is the global shutter image data by the block matching. The first pixel block RB1 of the first image data IDT1 (DAT1) and the first pixel block GB1 of the second image data IDT2 (DAT2) may have a relationship of a first motion vector MV1. Similarly, the second pixel block RB2 of the first image data IDT1 (DAT1) and the second pixel block GB2 of the second image data IDT2 (DAT2) may have a relationship of a second motion vector MV2.

Referring to FIG. 9D, in one or more embodiments, the processor 200 of FIG. 8A may synthesize the first image data IDT1 (DAT1) based on the second image data IDT2 (DAT2) and generate the third image data IDT3 (DAT3).

For example, the processor 200 may respectively determine the pixel locations of the first pixel block GRB1 and the second pixel block GRB2 of the third image data IDT3 (DAT3) based on the pixel locations of the first pixel block GB1 and the second pixel block GB2 of the second image data IDT2 (DAT2).

For example, the processor 200 may respectively determine the pixel values of the first pixel block GRB1 and the second pixel block GRB2 of the third image data IDT3 (DAT3) based on the pixel values of the first pixel block RB1 and the second pixel block RB2 of the first image data IDT1 (DAT1). As described above, the first pixel block RB1 and the second pixel block RB2 of the first image data IDT1 (DAT1) may have a relationship of the first motion vector MV1 and the second motion vector MV2 with the first pixel block GB1 and the second pixel block GB2 of the second image data IDT2 (DAT2), respectively.

According to one or more embodiment, when the processor 200 determines the pixel values of the pixel blocks of the third image data IDT3 (DAT3), the processor 200 may use various image processing, such as interpolation.

Referring to FIG. 9E, in one or more embodiments, the processor 200 of FIG. 8A may synthesize the second image data IDT2 (DAT2) based on the first image data IDT1 (DAT1) and generate the third image data IDT3 (DAT3).

For example, the processor 200 may generate at least one transformation matrix based on the motion vector field MF. The processor 200 may apply the transformation matrix to the pixel location of each of the pixel blocks of the first image data IDT1 (DAT1) to determine the pixel location of each of the pixel blocks of the third image data IDT3 (DAT3). For example, the processor 200 may respectively apply the transformation matrix based on the first motion vector MV1 and the transformation matrix based on the second motion vector MV2 to the pixel locations of the first pixel block RB1 and the second pixel block RB2 of the first image data IDT1 (DAT1) and respectively determine the pixel locations of the first pixel block RGB1 and the second pixel block RGB2 of the third image data IDT3 (DAT3).

For example, based on the pixel values of the first pixel block RB1 and the second pixel block RB2 of the first image data IDT1 (DAT1), the processor 200 may respectively determine the pixel values of the first pixel block RGB1 and the second pixel block RGB2 of the third image data IDT3 (DAT3).

As described above, the first pixel block RB1 and the second pixel block RB2 of the first image data IDT1 (DAT1) may have a relationship of the first motion vector MV1 and the second motion vector MV2 with the first pixel block GB1 and the second pixel block GB2 of the second image data IDT2 (DAT2), respectively.

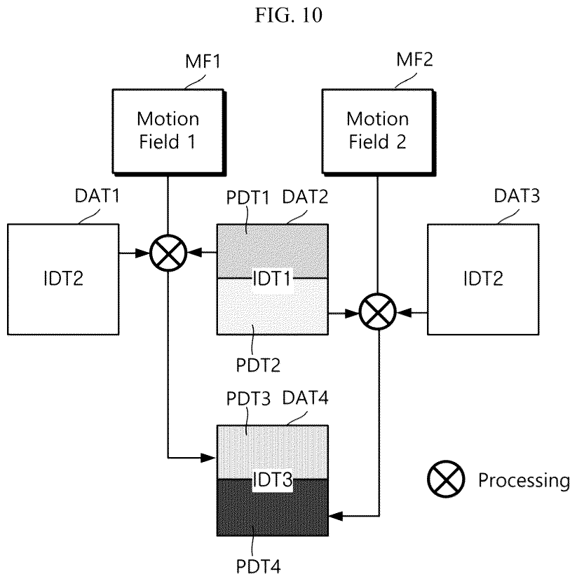

FIG. 10 is a diagram describing an operation in which the imaging apparatus according to the embodiment of FIG. 8B synthesizes the global shutter image data and the rolling shutter image data.

FIG. 10 is a diagram describing an operation in which the imaging apparatus 10 of FIG. 1 synthesizes the global shutter image data and the rolling shutter image data according to the one or more embodiment of FIG. 8B. Referring to FIGS. 8B and 10, a method in which the imaging apparatus 10 synthesizes two frames of the global shutter image data and one frame of the rolling shutter image data will be described. The method of FIG. 10 may be performed by the processor 200 of the imaging apparatus 10 of FIG. 1.

Referring to FIG. 10, in one or more embodiments, the processor 200 of FIG. 8B may process one frame of first image data IDT1 (DAT2) and two frames of a second image data IDT2 (DAT1 and DAT3) to output third image data IDT3 (DAT4). The processing may refer to performing synthesis by the processor 200.

For example, two frames of the second image data IDT2 (DAT1 and DAT3) may be the image data respectively captured before and after capturing the first image data IDT1 (DAT2). For example, the image sensor 100 of FIG. 8B may output one frame of the second image data IDT2 (DAT1) before the output of the first image data IDT1 (DAT2) and output the other frame of the second image data IDT2 (DAT3) after the output of the first image data IDT1 (DAT2).

The image data may include a plurality of pixel data. The processor 200 may display the image data on a display device or perform processing of the image data based on a pixel location and a pixel value of each of the plurality of pixel data.

In one or more embodiments, referring to FIG. 10, the processor 200 may process some pixel data PDT1 of the first image data IDT1 (DAT2) and one frame of the second image data IDT2 (DAT1) to generate at least some pixel data PDT3 of the third image data IDT3 (DAT4). In addition, the processor 200 may process the other pixel data PDT2 of the first image data IDT1 (DAT2) and the other frame of the second image data IDT2 (DAT3) to generate at least the other pixel data PDT4 of the third image data IDT3 (DAT4). The method of generating the pixel data of the third image data IDT3 (DAT4) may use the methods of FIGS. 9A to 9E.

Referring to the one or more embodiment of FIG. 10, by using both the second image data IDT2 (DAT1 and DAT3) captured before and after a shooting time of the first image data IDT1 (DAT2), the result of image synthesis in specific shooting conditions may be improved. For example, a rolling shutter effect may be further reduced in specific shooting conditions.

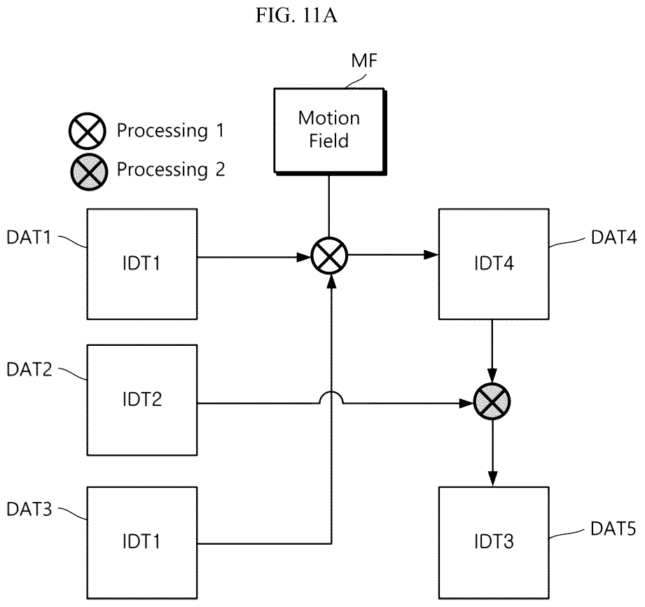

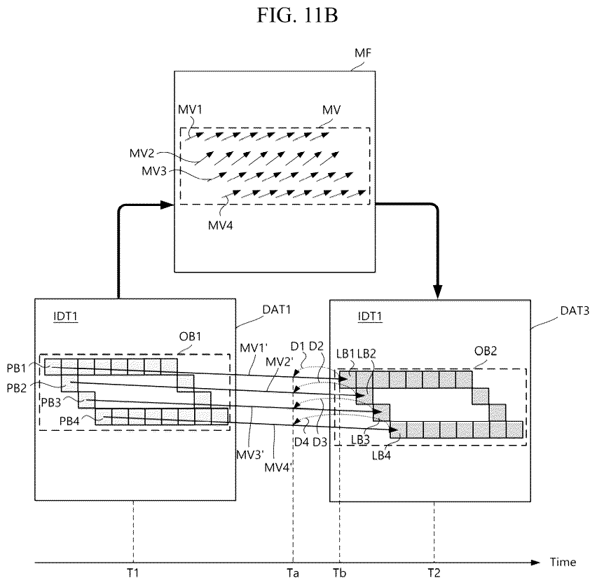

FIGS. 11A and 11B are diagrams describing operations in which the imaging apparatus according to the embodiment of FIG. 8C synthesizes the global shutter image data and the rolling shutter image data.

FIGS. 11A and 11B are diagrams describing operations in which the imaging apparatus 10 of FIG. 1 synthesizes the global shutter image data and the rolling shutter image data according to the one or more embodiment of FIG. 8C. Referring to FIGS. 8C, 11A, and 11B, a method is described in which the imaging apparatus 10 synthesizes one frame of the global shutter image data and two frames of the rolling shutter image data. The method of FIGS. 11A and 11B may be performed by the processor 200 of the imaging apparatus 10 of FIG. 1.

Referring to FIG. 11A, in one or more embodiments, the processor 200 of FIG. 8C may process two frames of first image data IDT1 (DAT1 and DAT3) and one frame of second image data IDT2 (DAT2) to output third image data IDT3 (DAT5). The processing may refer to performing synthesis by the processor 200.

For example, referring to FIG. 8C, two frames of first image data IDT1 (DAT1 and DAT3) may be the image data respectively captured before and after capturing the second image data IDT2 (DAT2). That is, the image sensor 100 of FIG. 8C may output one frame of the first image data IDT1 (DAT1) before the output of the second image data IDT2 (DAT2) and output the other frame of the first image data IDT1 (DAT3) after the output of the second image data IDT2 (DAT2).

Again, referring to FIG. 11A, the processor 200 of FIG. 8C may perform a first processing Processing 1 on two frames of the first image data IDT1 (DAT1 and DAT3) to generate fourth image data IDT4 (DAT4), and perform a second processing (Processing 2) on the second image data IDT2 (DAT2) and the fourth image data IDT4 (DAT4) to generate third image data IDT3 (DAT5). The processor 200 may output the third image data IDT3 (DAT5).

In one or more embodiments, the first processing Processing 1 and the second processing Processing 2 may be different processing. The second processing Processing 2 may be similar to the processing according to the one or more embodiments of FIGS. 9A to 9E.

FIG. 11B is a diagram describing one or more embodiments of the first processing Processing 1 of FIG. 11A.

FIG. 11B shows a first object OB1 composed of a plurality of pixel blocks of the first image data IDT1 (DAT1) of a frame captured at time T1 and a second object OB2 composed of a plurality of pixel blocks of the first image data IDT1 (DAT3) of a frame captured at time T2. Each pixel block may include at least one pixel data. The time T1 is an earlier time than the time T2.

In one or more embodiments, the processor 200 may perform block matching between two frames of the first image data IDT1 (DAT1 and DAT3) and determine a corresponding relationship based on the block matching. For example, the processor 200 may determine a motion vector field MF between two frames of the first image data IDT1 (DAT1 and DAT3) based on the block matching. The processor 200 may perform the block matching using various conventional methods and determine the motion vector field MF.

Referring to FIG. 11B, motion vectors MV1′, MV2′, MV3′, and MV4′ exemplarily shown between some blocks PB1, PB2, PB3, and PB4 of a first object OB1 and some pixel blocks LB1, LB2, LB3, and LB4 of a second object OB2 may be the same motion vectors as some motion vectors MV1, MV2, MV3, and MV4 of the motion vector field MF between two frames of the first image data IDT1 (DAT1 and DAT3). However, in order to describe the first processing Processing 1, the motion vectors MV1′, MV2′, MV3′, and MV4′ exemplarily shown are conceptually shown differently from the motion vectors MV1, MV2, MV3, and MV4 in FIG. 11B.

A first motion vector MV1′ is a motion vector that describes the corresponding relationship between a first pixel block PB1 of the first object OB1 and a first pixel block LB1 of the second object OB2. The first motion vector MV1′ may be described as the first pixel block PB1 of the first object OB1 captured at time T1 moving to a location of the first pixel block LB1 of the second object OB2 at time T2.

Similarly, a second motion vector MV2′, a third motion vector MV3′, and a fourth motion vector MV4′ may be described as a second pixel block PB2, a third pixel block PB3, and a fourth pixel block PB4 of the first object OB1 respectively moving to locations of a second pixel block LB2, a third pixel block LB3, and a fourth pixel block LB4 of the second object OB2.

In one or more embodiments, the processor 200 may determine a location at time Ta of the first pixel block PB1 of the first object OB1 as a location of a first pixel block of the fourth image data IDT4 (DAT4). Similarly, the processor 200 may determine that locations at time Ta of the second pixel block PB2, the third pixel block PB3, and the fourth pixel block PB4 of the first object OB1 are locations of a second pixel block, a third pixel block, and a fourth pixel block of the fourth image data IDT4 (DAT4), respectively.

Referring to FIG. 11B, a method by which the processor 200 calculates (obtains) the locations at time Ta of the first pixel block PB1, the second pixel block PB2, the third pixel block PB3, and the fourth pixel block PB4 of first object OB1 will be described.

In FIG. 11B, both of the two frames of the first image data IDT1 (DAT1 and DAT3) are the image data captured in the rolling shutter mode. Therefore, both of the first object OB1 and the second object OB2 may have rolling shutter effects. For example, as described with reference to FIG. 3B, the pixel blocks of the first object OB1 and the second object OB2 may include the pixel data generated based on photocharges integrated at different times in a column direction.

For example, as described with reference to FIG. 3B, the second pixel block LB2 of the second object OB2 may be captured at a first time later than time Tb at which the first pixel block LB1 is captured (at which the photocharges are integrated). Similarly, the third pixel block LB3 and the fourth pixel block LB4 of the second object OB2 may be respectively captured at a second time and a third time later than time Tb at which the first pixel block LB1 is captured.

In one or more embodiments, the processor 200 may determine that a location that moves from a location of the first pixel block PB1 of the first object OB1 along the first motion vector MV1′ for the time of Ta−T1 is a location at time Ta of the first pixel block PB1 of the first object OB1.

As another example, in one or more embodiments, the processor 200 may determine that a location that moves from a location of the first pixel block LB1 of the second object OB2 along the first motion vector MV1′ for the time of Tb−Ta=D1 is a location at time Ta of the first pixel block PB1 of the first object OB1. Similarly, the processor 200 may calculate (obtain) a location that moves from a location of the second pixel block LB2 of the second object OB2 along the second motion vector MV2′ for time D2, a location that moves from a location of the third pixel block LB3 along the third motion vector MV3′ for time D3, and a location that moves from a location of the fourth pixel block LB4 along the fourth motion vector MV4′ for time D4.

The times D2, D3, and D4 may be determined based on the difference between D1 and a shooting time of each row of the first image data IDT1 (DAT3) of the frame captured at time T2.

The pixel blocks of FIG. 11B may each include at least one pixel data. When the pixel blocks each include a plurality of pixel data, each of the plurality of pixel data in the same pixel block may have a different shooting time for each row. However, in one or more embodiments, the first processing may assume that the pixel data in the same pixel block have the same rolling shutter effect, and the processor 200 may perform the first processing. For example, the processor 200 may perform the first processing on the assumption that the pixel data in the same pixel block have captured at the same time.

Therefore, the embodiment of FIG. 11B may reduce the rolling shutter effect by using two frames of the first image data IDT1 (DAT1 and DAT3).

Subsequently, the processor 200 may perform the second processing on the fourth image data IDT4 (DAT4) with reduced rolling shutter effect and the second image data IDT2 (DAT2) of FIG. 11A captured in the global shutter mode. For example, the processor 200 may generate the third image data IDT3 (DAT5) of FIG. 11A based on a pixel value of the pixel data of the fourth image data IDT4 (DAT4) and a pixel location of the pixel data in the second image data IDT2 (DAT2) of FIG. 11A. Therefore, the processor 200 may generate an image frame with further reduced rolling shutter effect.

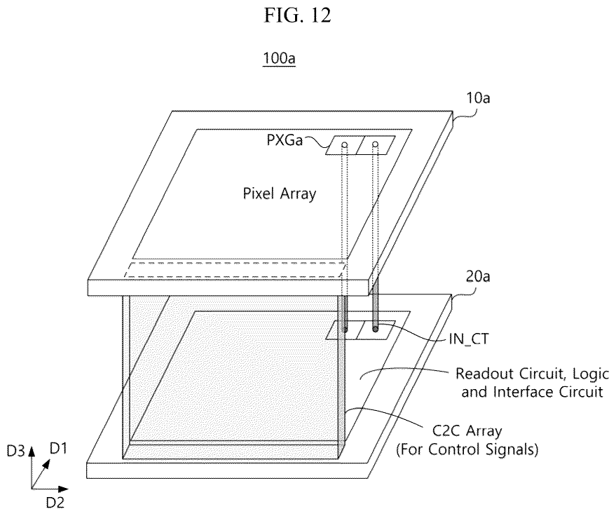

FIG. 12 is a block diagram describing an image sensor according to one or more embodiments.

FIG. 12 is a block diagram of an image sensor 100a according to one or more embodiments. Detailed descriptions for overlapping parts with those described above will be omitted. A pixel group PXGa of FIG. 12 may correspond to the pixel group PXGa of FIG. 5.

The image sensor 100a may include a first substrate 10a and second substrate 20a that are stacked. The first substrate 10a and the second substrate 20a may be connected to each other through a wafer bonding process using Cu-to-Cu (C2C) interconnection of a pixel group level. The first substrate 10a and the second substrate 20a may be electrically connected not only through an in-pixel contact IN_CT within the pixel group PXGa, but also through a C2C array located in a peripheral regions of the substrate. Control signals for controlling a pixel circuit may be transmitted through the C2C array. A pixel signal of the first substrate 10a may be transmitted to a readout circuit of the second substrate 20a through the in-pixel contact IN_CT.

In one or more embodiments, some pixel circuits may be located on the first substrate 10a, and other pixel circuits may be located on the second substrate 20a. For example, the first rolling-shutter circuit 113a and the second rolling-shutter circuit 114a of FIG. 5 may be located on the first substrate 10a, and the global selection circuit 115a and the global-shutter circuit 116a may be located on the second substrate 20a.

In one or more embodiments, all pixel circuits may be located on the second substrate 20a. For example, the plurality of pixels PX1, PX2, PX3, and PX4 that include photodiodes of FIG. 5 may be located on the first substrate 10a, and the first rolling-shutter circuit 113a, second rolling-shutter circuit 114a, global selection circuit 115a, and global-shutter circuit 116a may be located on the second substrate 20a.

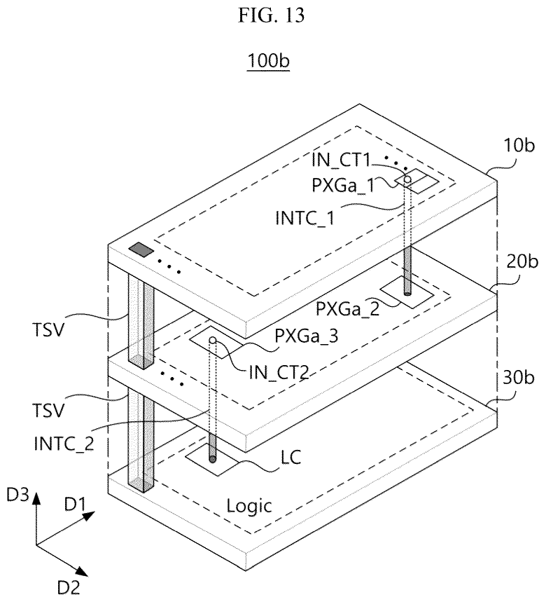

FIG. 13 is a block diagram describing an image sensor according to one or more embodiments.

FIG. 13 is a block diagram of an image sensor 100b according to one or more embodiments. Detailed descriptions for overlapping parts with those described above will be omitted.

Referring to FIG. 13, the image sensor 100b may include a first substrate 10b, a second substrate 20b, and a third substrate 30b. The third substrate 30b, the second substrate 20b, and the first substrate 10b may be sequentially stacked in a direction D3 perpendicular to a plane (a surface parallel to D1 and D2) of the substrate.

In one or more embodiments, some of circuits PXGa_1, PXGa_2, and PXGa_3 of the pixel group PXGa of FIG. 5 may be formed on each of the first substrate 10b and the second substrate 20b. A first partial circuit PXGa_1 of the pixel may be located on the first substrate 10b, and the remaining partial circuits PXGa_2 and PXGa_3 of the pixel may be located on the second substrate 20b. The third substrate 30b may include logic such as a readout circuit, a timing controller, or an image signal processor, and an interface circuit. The readout circuit may include an analog digital converter (ADC). In one or more embodiments, a logic circuit that performs scene analysis based on the neural network of image sensor 100, as described with reference to FIG. 7E, may be located on the third substrate 30b.

For example, the first rolling-shutter circuit 113a and the second rolling-shutter circuit 114a of FIG. 5 may be located on the first substrate 10b, and the global selection circuit 115a and the global-shutter circuit 116a may be located on the second substrate 20b.

Forms of circuits configuring the pixel group PXGa disposed on the first substrate 10b and the second substrate 20b are not limited thereto.

The first substrate 10b and the second substrate 20b may be electrically connected to each other.

In one or more embodiments, the first substrate 10b and the second substrate 20b may transmit a pixel signal or a control signal through a through silicon via TSV located in a peripheral region of the first substrate 10b and the second substrate 20b.

In one or more embodiments, the first partial circuit PXGa_1 of the pixel of the first substrate 10b and a second partial circuit PXGa_2 of the pixel of the second substrate 20b may also be electrically connected through a first inter-substrate connection structure INTC_1. The inter-substrate connection structure INTC_1 may be a C2C bonding contact or a deep-contact structure. The deep-contact structure may include the TSV. The inter-substrate connection structure INTC_1 may electrically connect an in-pixel contact IN_CT1 electrically connected to an element of the first partial circuit PXGa_1 of the pixel to an in-pixel contact IN_CT2 electrically connected to an element of the second partial circuit PXGa_2 of the pixel.

In one or more embodiments, the first substrate 10b and/or the second substrate 20b may be electrically connected to the third substrate 30b through the TSV and/or a second inter-substrate connection structure INTC_2. Signals of the first substrate 10b and/or the second substrate 20b may be transmitted to the readout circuit (or the image signal processor) of the third substrate 30b through the TSV and/or the second inter-substrate connection structure INTC_2.

In one or more embodiments, the second partial circuit PXGa_2 of the pixel group PXGa may be electrically connected to the circuits of the third substrate 30b through the C2C bonding contact. The second inter-substrate connection structure INTC_2 may include the C2C bonding contact.

In one or more embodiments, a third partial circuit PXGa_3 of the pixel group PXGa may be electrically connected to the circuits of the third substrate 30b through a thru-silicon copper (TSC).

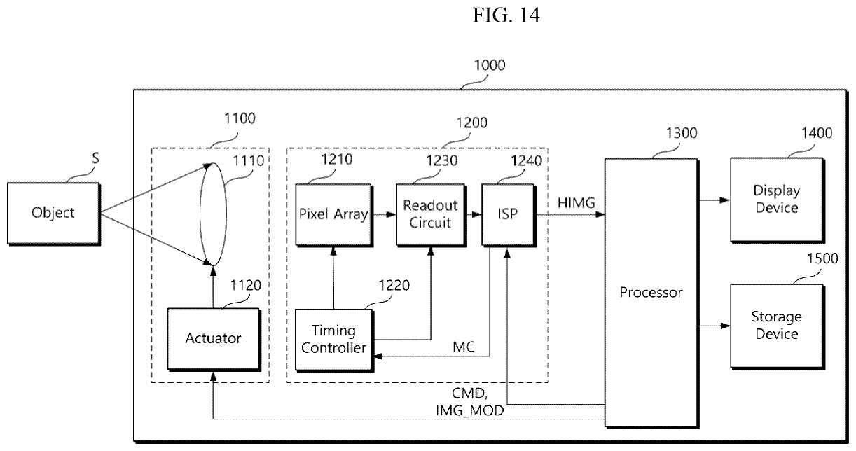

FIG. 14 is a block diagram describing an imaging apparatus according to one or more embodiments.

FIG. 14 is a block diagram of an electronic device according to one or more embodiments. Detailed descriptions for overlapping parts with those described above will be omitted.

The electronic device 1000 may include an imaging unit 1100, an image sensor 1200, a processor 1300, a display device 1400, and a storage device 1500.

The processor 1300 may control overall operations of the electronic device 1000. The processor 1300 may control a location of a lens 1110 by providing a control signal to a actuator 1120. As a result, a focal distance may be controlled.

The imaging unit 1100 is a component that receives light and may include the lens 1110 and the actuator 1120. The lens 1110 may include a plurality of lenses.

The actuator 1120 may move the lens 1110 in a direction in which a distance from an object S increases or in a direction in which a distance from an object S decreases based on the control signal of the processor 1300.

The image sensor 1200 may generate image data and phase data based on incident light. The image sensor 1200 may include a pixel array 1210, a timing controller 1220, a readout circuit 1230, and an image signal processor 1240.

Pixels of the pixel array 1210 may include at least one photoelectric conversion elements.

The pixels of the pixel array 1210 according to one or more embodiments may operate in a rolling shutter mode or a global shutter mode. The image signal processor 1240 may generate a mode control signal MC based on a shooting mode control signal IMG_MOD transmitted by the processor 1300. The pixels may operate in one of the rolling shutter mode or the global shutter mode based on the mode control signal MC transmitted by the image signal processor 1240.

Each of the pixels of the pixel array 1210 may be the pixel group PXGa described with reference to FIG. 4. Each of the pixels of the pixel array 1210 may include the circuits of the pixel group PXGa described with reference to FIG. 5.

The image signal processor 1240 may provide the mode control signal MC to the timing controller 1220. The timing controller 1220 may control an operation of the pixel array 1210 based on the mode control signal MC.

The image sensor 1200 may alternately operate in the rolling shutter mode and the global shutter mode to output at least one frame of rolling shutter image data and at least one frame of global shutter image data.

The processor 1300 may synthesize at least one frame of the rolling shutter image data and at least one frame of the global shutter image data, as described with reference to FIGS. 9A to 11B.

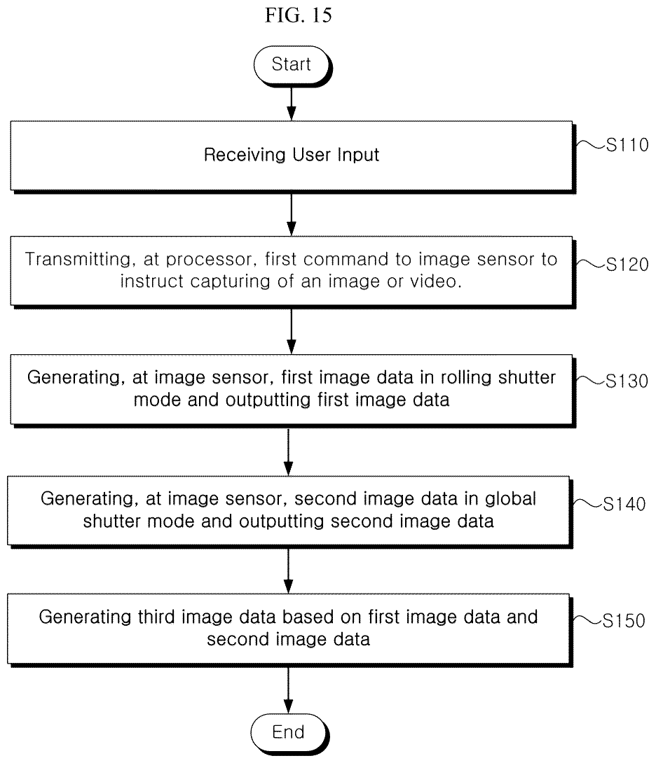

FIG. 15 is a flowchart describing an operating method of the imaging apparatus according to one or more embodiments. Detailed descriptions for overlapping parts with those described above will be omitted. The operation method of the image sensor of FIG. 15 may be performed in the imaging apparatus 10 of FIG. 1.

In operation S110, the imaging apparatus 10 may receive a user input that instructs to capture an image or a video. In one or more embodiments, the imaging apparatus 10 may be an electronic device provided with an image sensor, such as, for example, a mobile phone, a laptop computer, a security camera, a surveillance camera, a tablet computer, or a smartphone. The imaging apparatus 10 may receive the user input to capture a still image or capture a video from a user through a user interface that is not particularly limited, such as a graphical user interface or a shooting button.

In operation S120, the processor 200 of the imaging apparatus 10 of FIG. 1 may transmit a first command that instructs to capture an image or a video to the image sensor in response to the user input. In one or more embodiments, the first command may be the shooting command SHOT_CMD described with reference to FIGS. 7B to 7E. The shooting command SHOT_CMD may be a command that instructs to capture a still image or a video. In one or more embodiments, the processor 200 may transmit a mode control command along with the first command. The mode control command may be one of a plurality of mode control commands. For example, the mode control command may be one of the mode control commands IMG_MOD1, IMG_MOD2, and IMG_MOD3 described with reference to FIGS. 7B to 7E.

In operation S130, the image sensor 100 of FIG. 1 may generate first image data in a rolling shutter mode in response to the first command and may output the first image data. In operation S140, the image sensor 100 of FIG. 1 may generate second image data in a global shutter mode in response to the first command and may output the second image data. Operations S130 and S140 may be performed in any order. For example, the image sensor 100 may perform operation S140 after performing operation S130 or perform operation S130 after performing operation S140.

Operations S130 and S140 may be performed based on the one or more embodiments described with reference to FIGS. 7B to 7E.

In operation S150, the processor 200 of FIG. 1 may generate third image data based on the first image data and the second image data. For example, the processor 200 may synthesize at least one frame of rolling shutter image data and at least one frame of global shutter image data based on the one or more embodiments described with reference to FIGS. 9A to 11B and generate the third image data.

An imaging apparatus and an operating method of the imaging apparatus according to one or more embodiments may generate an image with reduced rolling shutter effect and noise. Therefore, the quality of the image may be improved.

While embodiments have been described with reference to the figures, it will be understood by those of ordinary skill in the art that various changes in form and details may be made therein without departing from the spirit and scope as defined by the following claims and their equivalents.

What is claimed is:

1. An imaging apparatus comprising:
an image sensor comprising a pixel array that comprises a plurality of pixels in a matrix form, the image sensor being configured to output first image data captured in a rolling shutter mode and second image data captured in a global shutter mode; and
at least one processor configured to process the first image data and the second image data and output third image data based on the processing.

2. The imaging apparatus of claim 1, wherein the image sensor is further configured to output at least one of the first image data and the second image data based on a shooting command by the at least one processor.

3. The imaging apparatus of claim 1, wherein the image sensor is further configured to alternately output the first image data and the second image data based on a shooting command of the at least one processor.

4. The imaging apparatus of claim 1, wherein each of the first image data and the second image data comprises information instructing a shooting mode of one of the rolling shutter mode and the global shutter mode.

5. The imaging apparatus of claim 1, wherein the at least one processor is further configured to generate the third image data based on a pixel value of first pixel data of the first image data and a pixel location of second pixel data of the second image data.

6. The imaging apparatus of claim 1, wherein, based on a first location of first pixel data of the first image data and a second location of second pixel data of the second image data, the at least one processor is further configured to:
determine a relationship between the first location and the second location;
obtain a third location by converting the first location of the first pixel data of the first image data based on the relationship; and
generate the third image data based on the third location.

7. The imaging apparatus of claim 1, wherein the at least one processor is further configured to:
process two frames of the first image data and one frame of the second image data; and
output the third image data based on the processing.

8. The imaging apparatus of claim 7, wherein the at least one processor is further configured to:
generate fourth image data based on a motion vector field between the two frames of the first image data; and
generate pixel data of the third image data based on a pixel value of pixel data of the fourth image data and a pixel location of the pixel data of the second image data.

9. The imaging apparatus of claim 1, wherein the image sensor is further configured to output fourth image data in the global shutter mode, and
wherein the at least one processor is further configured to process the first image data, the second image data, and the fourth image data, and output the third image data based on the processing.

10. The imaging apparatus of claim 9, wherein the at least one processor is further configured to:
process the first image data and the second image data to generate at least a first portion of the third image data, and
process the first image data and the fourth image data to generate a second portion of the third image data other than the first portion of the third image data.

11. The imaging apparatus of claim 9, wherein the image sensor is further configured to output the second image data before outputting the first image data and output the fourth image data after outputting the first image data.

12. The imaging apparatus of claim 1, wherein the at least one processor is further configured to transmit one of a first mode control command and a second mode control command to the image sensor based on an illumination,
wherein the image sensor is further configured to output the first image data and the second image data based on the first mode control command and output the first image data based on the second mode control command, and
wherein the at least one processor is further configured to generate the second mode control command at an illumination lower than an illumination at which the first mode control command is generated.

13. The imaging apparatus of claim 1, wherein the image sensor is further configured to:
output the first image data captured in the rolling shutter mode based on a preview command received from the at least one processor, and
output the first image data captured in the rolling shutter mode and the second image data captured in the global shutter mode based on a shooting command received from the at least one processor.

14. An imaging apparatus comprising:
an image sensor comprising a pixel array that comprises a plurality of pixels in a matrix form, the image sensor being configured to generate first image data in a rolling shutter mode and second image data in a global shutter mode based on a shooting command received from at least one processor, and output the first image data and the second image data;
a memory device configured to store the first image data, the second image data, and stores at least one command executed by the at least one processor, the memory device being electrically connected to the at least one processor; and
the at least one processor configured to execute the shooting command to transmit the shooting command to the image sensor based on a user input that instructs to capture an image or a video and generate third image data by changing a pixel location of pixel data of the first image data based on the second image data or by changing a pixel value of pixel data of the second image data based on the first image data.

15. The imaging apparatus of claim 14, wherein the at least one processor is further configured to determine a pixel location of pixel data of the third image data based on a pixel location of pixel data of the second image data.

16. The imaging apparatus of claim 14, wherein the at least one processor is further configured to determine a pixel value of pixel data of the third image data based on a pixel value of pixel data of the first image data.

17. The imaging apparatus of claim 14, wherein the at least one processor is further configured to determine a motion vector field between the first image data and the second image data and determine a pixel location of pixel data of the third image data based on the motion vector field.

18. The imaging apparatus of claim 14, wherein the at least one processor is further configured to transmit a mode control command to the image sensor based on an illumination, and
wherein the image sensor is further configured to generate the first image data and the second image data based on the mode control command.

19. An operating method of an imaging apparatus, comprising:
receiving a user input that instructs to capture an image or a video;
transmitting, by at least one processor, a first command that instructs to capture the image or the video to an image sensor based on the user input;
generating, by the image sensor, first image data in a rolling shutter mode based on the first command;
outputting, by the image sensor, the first image data;
generating, by the image sensor, second image data in a global shutter mode based on the first command;
outputting, by the image sensor, the second image data; and
generating, by the at least one processor, third image data based on the first image data and the second image data.

20. The imaging apparatus of claim 19, wherein the outputting of the first image data occurs before the outputting of the second image data or the outputting of the first image data occurs after the outputting of the second image data.
